(19) United States
(12) Patent Application Publication
(10) Pub. No.: US 2008/0259206 A1
(43) Pub. Date: Oct. 23, 2008

(54) ADAPATIVE DE-INTERLACER AND METHOD THEREOF

(75) Inventors: Yi Pin Lu, Tainan County (TW); Chang Hsien Tai, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/736,442

(22) Filed: Apr. 17, 2007

(51) Int. Cl. H04N 11/20

(52) U.S. Cl. 348/448; 348/E11.021

(57) ABSTRACT

An adaptive de-interlacer can convert an interlaced video signal into a progressive video signal, and comprises an intra-field interpolator, an inter-field interpolator, a static pixel detector, a motion detector and a blending unit. The intra-field interpolator outputs an intra-field interpolated pixel based on a current field of the interlaced video signal, and the inter-field interpolator outputs an inter-field interpolated pixel based on successive fields of the interlaced video signal. The static pixel detector detects whether each interpolated pixel is a static pixel based on luminance differences between pixels of the successive fields with reference to a threshold and outputs a detection result. The motion detector generates a motion value for the interpolated pixel based on the successive fields and the detection result. The blending unit mixes the intra-field interpolated pixel and inter-filed interpolated pixel based on the motion value and the detection result so as to determine the interpolated pixel.

### BACKGROUND OF THE INVENTION

1. Field of the Invention

The present invention relates to video processing, and more particularly relates to adaptive de-interlacing which can correctly verifies static pixels in view of DC and AC luminance differences between pixels in successive frames.

2. Description of the Related Art

Several known de-interlacing methods can convert an interlaced video signal to a progressive video signal. An interlaced video signal includes a succession of fields, each field including a plurality of scanning lines. Two successive fields of an interlaced video signal can define a frame where the first field includes the odd scanning lines (e.g., scanning lines 1, 3, 5, 7, etc.) and the second field includes the even scanning lines (e.g., 2, 4, 6, 8, etc.).

A de-interlacing method generates a line of interpolated pixels between every two successive lines of a field. Examples of known de-interlacing methods of de-interlacing an interlaced video signal include inter-field interpolation (known as temporal interpolation) and intra-field interpolation (known as spatial interpolation). In an area with little or no motion, inter-field interpolation is preferred. By contrast, in an area with high motion, intra-field interpolation is preferred.

An alternative form of de-interlacing employs alpha blending, which attempts to mix both inter-field interpolation and intra-field interpolation based on motion in a picture. Such de-interlacing methods often depend upon vast computational resources to operate effectively, and can still produce mismatching errors when static pixels cannot be correctly detected due to noise interferences, that is likely to improperly incorporate intra-field interpolation and blur the picture.

In view of the foregoing, it can be appreciated that a substantial need exists for an adaptive de-interlacer and method thereof that can verify static pixels for more proper de-interlacing.

### SUMMARY OF THE INVENTION

An objective of the present invention is to provide an adaptive de-interlacer and an adaptive de-interlacer method which can correctly verifies static pixels in view of DC and AC luminance differences between pixels in successive frames.

In order to achieve the objectives, the present invention provides an adaptive de-interlacer for converting an interlaced video signal into a progressive video signal. The adaptive de-interlacer comprises an intra-field interpolator, an inter-field interpolator, a static pixel detector, a motion detector and a blending unit. The intra-field interpolator outputs an intra-field interpolated pixel based on a current field of the interlaced video signal, and the inter-field interpolator outputs an inter-field interpolated pixel based on successive fields of the interlaced video signal. The static pixel detector detects whether each interpolated pixel is a static pixel based on luminance differences between pixels of the successive fields with reference to a threshold and outputs a detection result. The motion detector generates a motion value for the interpolated pixel based on the successive fields and the detection result. The blending unit mixes the intra-field interpolated pixel and inter-filed interpolated pixel based on the motion value and the detection result so as to determine the interpolated pixel.

In accordance with the present invention, an adaptive de-interlacer for converting an interlaced video signal into a progressive video signal is provided. An intra-field interpolated pixel is outputted based on a current field of the interlaced video signal, and an inter-field interpolated pixel is outputted based on successive fields of the interlaced video signal. Whether each interpolated pixel is a static pixel based on luminance differences between pixels of the successive fields with reference to a threshold is detected to output the corresponding detection result. A motion value is generated for the interpolated pixel based on the successive fields and the detection result. Final, the intra-field interpolated pixel and inter-filed interpolated pixel are mixed based on the motion value and the detection result so as to determine the interpolated pixel.

### BRIEF DESCRIPTION OF THE DRAWINGS

The invention will be described according to the appended drawings in which:

FIGS. 1(a)-1(d) show successive fields of an interlaced video signal used in accordance with an embodiment of the present invention;

FIG. 2 is a function block diagram of an adaptive de-interlacer in accordance with an embodiment of the present invention;

FIG. 3 is a block diagram showing a static pixel detector in accordance with an embodiment of the present invention; and

FIG. 4 is a graph showing the relation between compensation threshold values and luminance in accordance with an embodiment of the present invention.

### DETAILED DESCRIPTION OF THE INVENTION

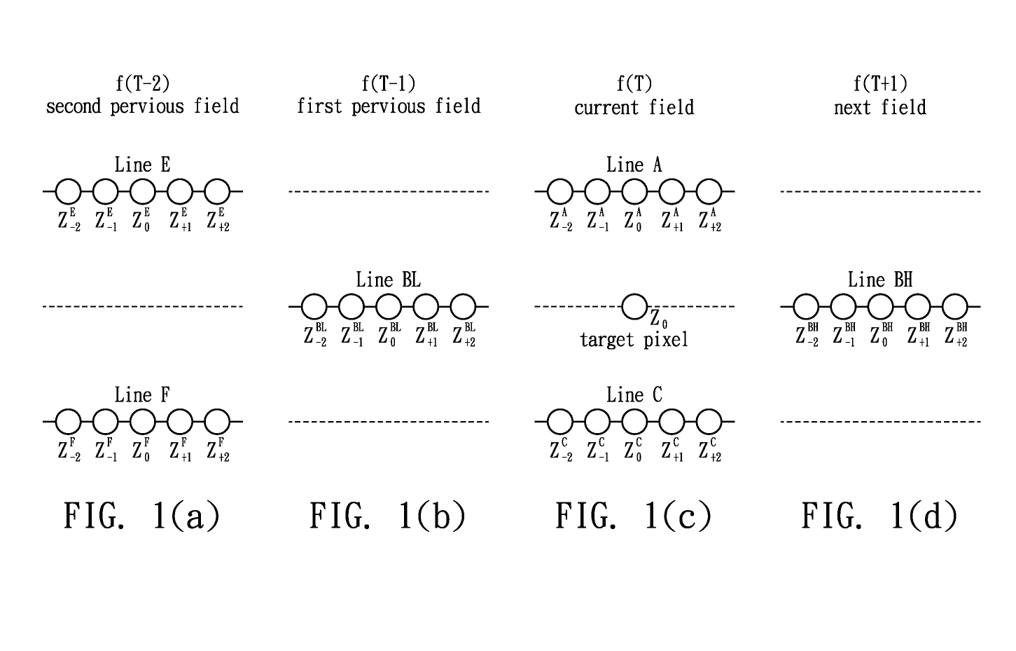

FIGS. 1(a)-1(d) show successive fields of an interlaced video signal used in accordance with an embodiment of the present invention. The interlaced video signal has a succession of fields. The adaptive de-interlacer and its method in accordance with embodiments of the present invention can generate a progressive frame by including lines of interpolated pixels such as the interpolated pixel Z₀ based in part on pixel values from a second previous field f(T−2), a first previous field f(T−1), a current field f(T) and a next field f(T+1) of the interlaced video signal. The current field f(T) has a pixel Z₀^{A} of a scanning line A and a pixel Z₀^{C} of a scanning line C. The pixels Z₀^{A} and Z₀^{C} are the pixels respectively right above and right below the target pixel Z₀. There are pixels such as Z₋₂²A and Z₋₁^{A} preceding the pixel Z₀^{A} and pixels such as Z₊₁^{A} and Z₊₂^{A} succeeding the pixel Z₀^{A} on the scanning line A. Similarly, there are pixels such as Z₋₂^{C} and Z₋₁^{C} preceding the pixel Z₀^{C} and pixels such as Z₊₁^{C} and Z₊₂^{C} succeeding the pixel Z₀^{C} on the scanning line C.

Furthermore, a pixel Z₀^{BH} of the scanning line BH is the next pixel in the next field f(T+1) at the same spatial location as the interpolated pixel Z₀, and a pixel Z₀^{BL} of the scanning line BL is the previous pixel in the first previous field f(T−1) at the same spatial location as the interpolated pixel Z₀. Within the period of the second previous field f(T−2), the scanning line E occurs at the same horizontal as the scanning line A, and the scanning line F occurs at the same horizontal as the scanning line C. A pixel Z₀^{E} of the scanning line E is at the same spatial location as the pixel Z₀^{A}, and a pixel Z₀^{F} of the scanning line F is at the same spatial location as the pixel Z₀^{C}.

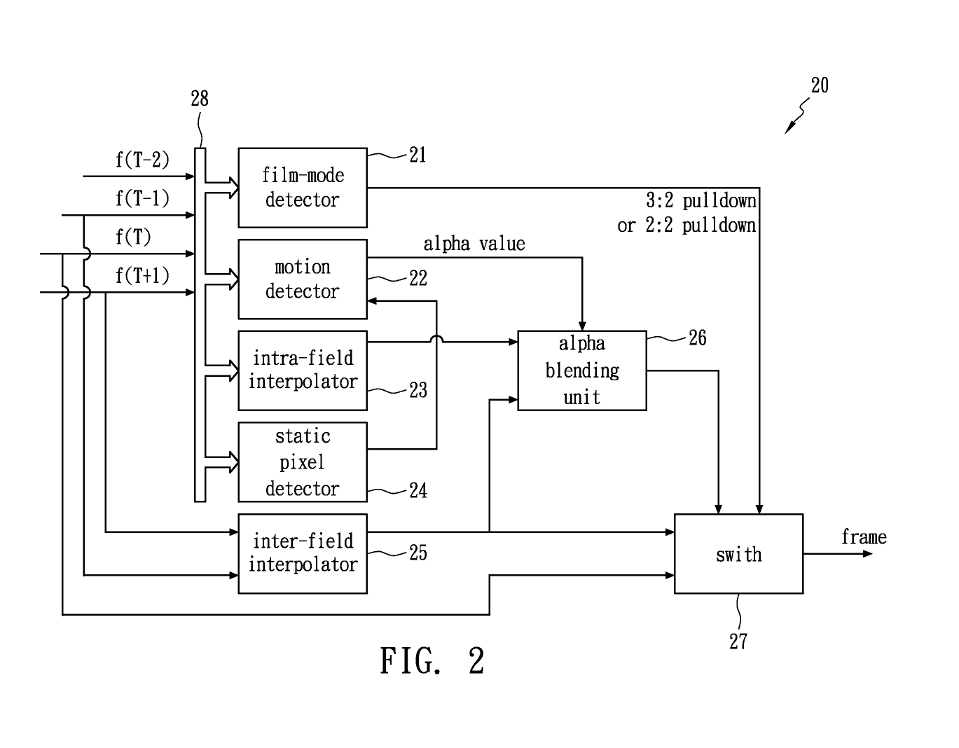

FIG. 2 is a function block diagram of an adaptive de-interlacer in accordance with an embodiment of the present invention. As shown in FIG. 2, the adaptive de-interlacer 20 comprises a film-mode detector 21, a motion detector 22, an intra-field interpolator 23, a static pixel detector 24, an inter-field interpolator 25, an alpha blending unit 26 and a soft switch 27. The motion detector 22 can generate an alpha value (or a motion value) for each interpolated pixel such as the interpolated pixel Z₀ based on successive fields f(T−2), f(T−1), f(T) and f(T+1) of the interlaced video signal and the detection result of the static pixel detector 24. The intra-field interpolator 23 also receives data for the current field f(T) and yields an intra-field interpolated pixel. Similarly, the inter-field interpolator outputs an inter-field interpolated pixel on the basis of the fields f(T−1) and f(T+1).

The static pixel detector 24 detects whether the interpolated pixel Z₀ in the current field f(T) is a static pixel by reference to DC and AC luminance differences between pixels in the successive fields, and outputs the detection result to the motion detector 22. That is, the static pixel detector 24 first calculates the DC luminance differences between pixels of the second previous field f(T−2) and the current field f(T) and DC luminance differences between pixels of the first previous field f(T−1) and the next field f(T+1), the pixels having the same locations as the interpolated pixel Z₀ or adjacent to the interpolated pixel Z₀ in the successive fields. Subsequently, the static pixel detector 24, on the basis of the DC luminance differences, can output static detectors with reference to a threshold. Furthermore, the static pixel detector 24 compares the luminance difference between pixels of the first previous field f(T−1) and the current field f(T) and the luminance difference between pixels of the second previous field f(T−2) and the next field f(T+1) to output an AC luminance difference. With the static detectors and the AC luminance difference, a still flag can be output by the static pixel detector 24. The motion detector 22 can generate a motion value or an alpha value for the interpolated pixel Z₀ based on the detection result from the static pixel detector 24 in addition to pixels in the successive fields. The alpha blending unit 26, knowing the static pixel detection, can mix the intra-field interpolated pixel and inter-field interpolated pixel more properly.

The film-mode detector 21 detects whether the interlaced video signal is in film mode based on the successive fields f(T−2), f(T−1), f(T) and f(T+1), so as to perform 3:2 or 2:2 pulldown when necessary (not shown FIG. 2). Finally, the switch 27 outputs a progressive frame by combining the current field f(T) to an interpolated field generated by the intra-field interpolator 23 and/or the inter-field interpolator 25 in view of the alpha value output from the alpha blending unit 26 and the static pixel detection output from the static pixel detector 24, or by combining the current field f(T) to the 3:2 or 2:2 pulldown when the interlaced video signal is in film mode.

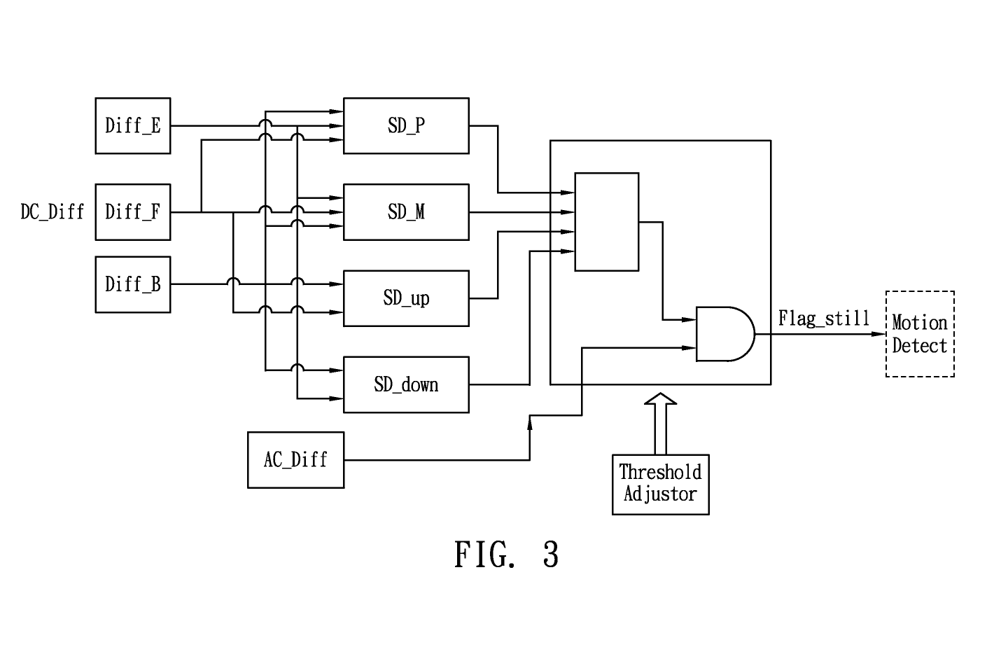

FIG. 3 is a block diagram showing a static pixel detector in accordance with an embodiment of the present invention. Exemplified with the target pixel Z₀, whether or not the interpolated pixel Z₀ is a static pixel could be determined on the basis of the luminance differences between pixels in the successive fields. As shown in FIG. 3, a calculation is performed to obtain DC luminance differences Diff_E(i) and Diff_F(i) between the pixels of a second previous field f(T−2) and a current field f(T) and DC luminance differences Diff₋B(i) between the pixels of a first previous field f(T−1) and a next field f(T+1). Diff_E(i), Diff_F(i) and Diff_B(i) are respectively defined as follows:

Diff_{—}E(i)=|L(Zᵢ^{A})−L(Zᵢ^{E})|

Diff_{—}F(i)=|L(Zᵢ^{C})−L(Zᵢ^{F})|

Diff_{—}B(i)=|L(Zᵢ^{BL})−L(Zᵢ^{BH})|

where L(.) represents the luminance of the corresponding pixel.

Next, another calculation is performed on the basis of the DC luminance differences and with reference to a threshold Thd1 to output static detectors SD_p, SD_m, SD_up and SD_down, which are respectively defined below:

$$SD\_p = {\sum }_{i = 0}^{+ 5} ( ⋂ ( Diff\_E ( i ) \leq Thd 1 ) ) ⋂ {\sum }_{i = 0}^{+ 5} ( ⋂ ( Diff\_F ( i ) \leq Thd 1 ) ) {\sum }_{i = 0}^{+ 5} ( ⋂ ( Diff\_B ( i ) \leq Thd 1 ) )$$

$$SD\_m = {\sum }_{i = 0}^{- 5} ( ⋂ ( Diff\_E ( i ) \leq Thd 1 ) ) ⋂ {\sum }_{i = 0}^{- 5} ( ⋂ ( Diff\_F ( i ) \leq Thd 1 ) ) {\sum }_{i = 0}^{- 5} ( ⋂ ( Diff\_B ( i ) \leq Thd 1 ) )$$

$$SD\_up = {\sum }_{i = - 5}^{+ 5} ( ⋂ ( Diff\_E ( i ) \leq Thd 1 ) ) ⋂ {\sum }_{i = - 5}^{+ 5} ( ⋂ ( Diff\_B ( i ) \leq Thd 1 ) )$$

$$SD\_down = {\sum }_{i = - 5}^{+ 5} ( ⋂ ( Diff\_F ( i ) \leq Thd 1 ) ) ⋂ {\sum }_{i = - 5}^{+ 5} ( ⋂ ( Diff\_B ( i ) \leq Thd 1 ) )$$

where Thd1 denotes an adjustable threshold value.

At the same time, another calculation is performed to obtain AC luminance difference AC_Diff by comparing the luminance difference between the pixels of the first previous field f(T−1) and the current field f(T) and the luminance difference between the pixels of the second previous field f(T−2) and the next field f(T+1), which is expressed as follows:

AC_Diff=|L(Zᵢ^{BL})−L(Zᵢ^{A})|−|L(Zᵢ^{BH})−L(Zᵢ^{E})|

Next, the interpolated pixel is determined as a static pixel according to a still flag Flag_still output on the basis of the static detectors and AC luminance difference SD_p, SD_m, SD_up, SD_down and AC_Diff, that is defined as follows:

Flag_still=(SD_{—}p∪SD_{—}m∪SD_up∪SD_down)∩AC_Diff

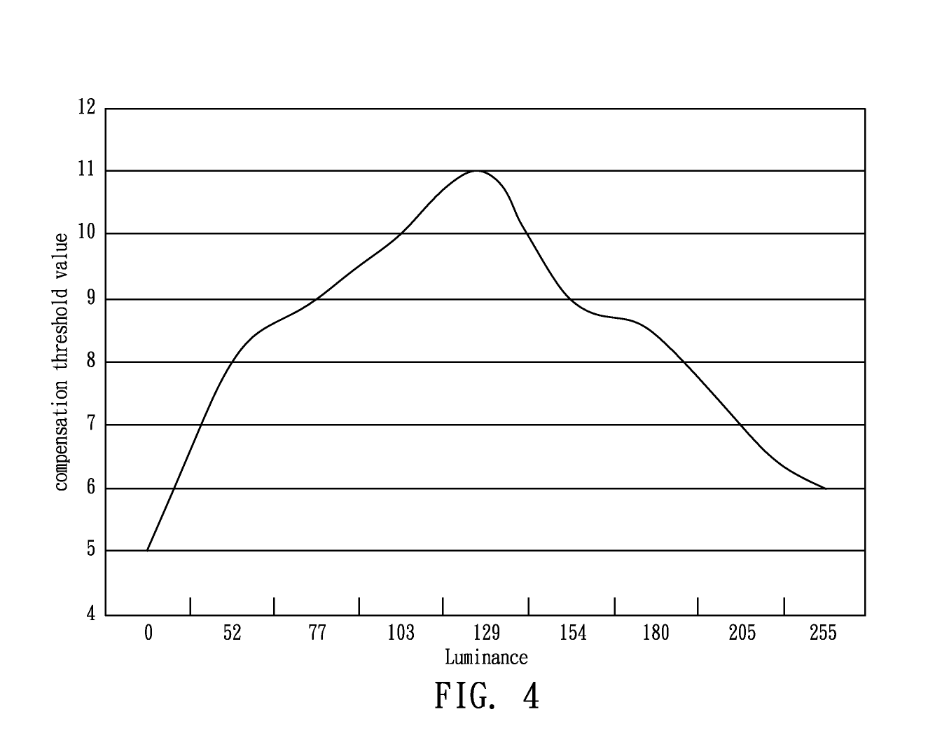

In addition, to further detect non-static pixels in case the luminance differences are small, the threshold Thd1 is adjustable. First, a reference value thd_min is set. For example, the reference value thd_min is preferably set to 128, when the pixel data is 8-bit. Afterward, the reference value thd_min is compared with the smaller one of L(Zᵢ^{BL}) and L((Zᵢ^{BH}). If the smaller one of L(Zᵢ^{BL}) and L((Zᵢ^{BH}) is larger than the reference value thd_min, the threshold Thd1 is equal to a first default value thd_a plus a compensation threshold value. The compensation threshold value is defined by the graph in FIG. 4. For example, L(Zᵢ^{BL}) is the smaller one and larger than the thd_min so that the compensation threshold value is determined by finding a point on the curve corresponding to the value of L(Zᵢ^{BL}) on the abscissa axle. However, if the smaller one of L(Zᵢ^{BL}) and L((Zᵢ^{BH}) is smaller than the reference value thd_min, the threshold Thd1 is equal to a second default value thd_b plus a compensation threshold value. The graph in FIG. 4 can be converted into numerical data stored in a look-up table. Because the numerical data or the graph in FIG. 4 is based on the viewer's visual sense, the threshold Thd1 obtained by foregoing steps is adjustable to what the viewer sees.

The above-described embodiments of the present invention are intended to be illustrative only. Numerous alternative embodiments may be devised by persons skilled in the art without departing from the scope of the following claims.

What is claimed is:

1. An adaptive de-interlacer converting an interlaced video signal into a progressive video signal, comprising:
an intra-field interpolator outputting an intra-field interpolated pixel based on a current field of the interlaced video signal;
an inter-field interpolator outputting an inter-field interpolated pixel based on successive fields of the interlaced video signal;
a static pixel detector detecting whether each interpolated pixel is a static pixel based on luminance differences between pixels of the successive fields with reference to a threshold and outputting a detection result;
a motion detector generating a motion value for the interpolated pixel based on the successive fields and the detection result; and
a blending unit mixing the intra-field interpolated pixel and inter-filed interpolated pixel based on the motion value and the detection result so as to determine the interpolated pixel.

2. The adaptive de-interlacer of claim 1, further comprising a switch outputting a progressive frame based on data from the alpha blending unit and the current field.

3. The adaptive de-interlacer of claim 1, further comprising a film-mode detector detecting whether or not the interlace video signal is in film mode so as to perform 3:2 or 2:2 pulldown.

4. The adaptive de-interlacer of claim 3, wherein the switch combines the current field and its 3:2 or 2:2 pulldown to output the progressive frame when the interlaced video signal is in film mode.

5. The adaptive de-interlacer of claim 1, wherein the static pixel detector is configured to:
calculate DC luminance differences between pixels of a second previous field and the current field and DC luminance differences between pixels of a first previous field and a next field;
determine static detectors based on the luminance differences and in view of a threshold;
determine an AC luminance difference on the basis of a luminance difference between pixels of the first previous field and the current field and a luminance difference between pixels of the second previous field and the next field; and
determine a still flag based on the static detectors and the AC luminance difference to recognize whether or not the interpolated pixel is a static pixel.

6. The adaptive de-interlacer of claim 1, wherein the threshold value is determined according to a look-up table.

7. The adaptive de-interlacer of claim 6, wherein data of the look-up table are related to visual sensitivity.

8. An adaptive de-interlacing method converting an interlaced video signal into a progressive video signal, comprising:
outputting an intra-field interpolated pixel based on a current field of the interlaced video signal;
outputting an inter-field interpolated pixel based on successive fields of the interlaced video signal;
detecting whether each interpolated pixel is a static pixel based on luminance differences between pixels of the successive fields with reference to a threshold and outputting a detection result;
generating a motion value for the interpolated pixel based on the successive fields and the detection result; and
mixing the intra-field interpolated pixel and inter-filed interpolated pixel based on the motion value and the detection result so as to determine the interpolated pixel.

9. The adaptive de-interlacing method of claim 8, further comprising:
outputting a progressive frame based on data from the alpha blending unit and the current field.

10. The adaptive de-interlacing method of claim 8, further comprising:
detecting whether or not the interlace video signal is in film mode so as to perform 3:2 or 2:2 pulldown.

11. The adaptive de-interlacing method of claim 10, wherein the step of outputting the progressive frame comprises:
combining the current field and its 3:2 or 2:2 pulldown to output the progressive frame when the interlaced video signal is in film mode.

12. The adaptive de-interlacing method of claim 8, wherein the static pixel detecting step further comprises:
calculating DC luminance differences between pixels of a second previous field and the current field and DC luminance differences between pixels of a first previous field and a next field;
determining static detectors based on the DC luminance differences and in view of a threshold;
determining an AC luminance difference by comparing a luminance difference between pixels of the first previous field and the current field and a luminance difference between pixels of the second previous field and the next field; and
determining a still flag based on the static detectors and the AC luminance difference to recognize whether or not the interpolated pixel is a static pixel.

13. The adaptive de-interlacing method of claim 8, wherein the threshold value is determined according to a look-up table.

14. The adaptive de-interlacing method of claim 13, wherein data of the look-up table are related to visual sensitivity.
